(19) United States
(12) Patent Application Publication
(10) Pub. No.: US 2020/0167645 A1
(43) Pub. Date: May 28, 2020

(54) INFORMATION PROCESSING AND MODEL TRAINING METHODS, APPARATUSES, ELECTRONIC DEVICES, AND STORAGE MEDIUMS

(71) Applicant: Beijing Kingsoft Internet Security Software Co., Ltd., Beijing (CN)

(72) Inventor: Hsien-de HUANG, Beijing (CN)

(21) Appl. No.: 16/480,925

(22) PCT Filed: May 24, 2018
(86) PCT No.: PCT/CN2018/088249

§ 371 Date: Jul. 25, 2019

(30) Foreign Application Priority Data
Jun. 30, 2017 (CN) 201710525652.0

(51) Int. Cl. G06N 3/08; H04L 29/08; G06F 3/14; G06N 3/04; G06F 9/451

(52) U.S. Cl. CPC G06N 3/08; H04L 67/26; G06F 9/451; G06N 3/04; G06F 3/14

(57) ABSTRACT

Embodiments of the present application provide information processing and model training methods, apparatuses, electronic devices and storage mediums. The method includes: obtaining to-be-processed pop-up information sent to an electronic device; inputting the to-be-processed pop-up information into a pop-up management model; wherein the pop-up management model is a model that is constructed based on a deep neural network and configured for determining whether the input pop-up information is pop-up information that is of interest to a user; wherein the pop-up information that is of interest to the user is information whose degree of attention is greater than a threshold; if an output result of the pop-up management model is information indicating that the to-be-processed pop-up information is the pop-up information that is of interest to the user, sending the to-be-processed pop-up information to an electronic device, so that the electronic device displays the to-be-processed pop-up information through a pop-up function. With the embodiments of the present application, the problem that the electronic device displays a large amount of pop-up information that is not of interest to a user is solved, and thus the user experience is improved.

The present application claims the priority to a Chinese patent application No. 201710525652.0 filed with the China National Intellectual Property Administration Jun. 30, 2017 and entitled “Information Processing and Model Training Methods, Apparatuses, Electronic Devices, and Storage Mediums”, which is incorporated herein by reference in its entirety.

### TECHNICAL FIELD

The present disclosure relates to the field of Internet technology, and in particular, to information processing and model training methods, apparatuses, electronic devices, and storage mediums.

### BACKGROUND

At present, in order to make it easy to timely obtain and view, by a user, information of interest, an electronic device such as a smart phone, a tablet, a laptop, and the like is provided with a pop-up function. When the electronic device receives information, the information is displayed through the pop-up function. At this time, the information that needs to be displayed through the pop-up function may be referred to as pop-up information.

With the development of technology, there are more and more pop-up information in the network. In the pop-up information, there is a lot of pop-up information that is not of interest to the user. If the pop-up information is all sent to the electronic device, the direct result is that the electronic device displays a large amount of pop-up information that is not of interest to the user through the pop-up function, which affects the normal use of the electronic device by the user, and brings a poor user experience.

### SUMMARY

An object of the present disclosure is to provide information processing and model training methods, apparatuses, electronic devices, and storage mediums, so as to solve the problem that an electronic device displays a large amount of pop-up information that is not of interest to a user. The specific technical solutions are as follows.

In a first aspect, an embodiment of the present application provides an information processing method, including:

obtaining to-be-processed pop-up information;

inputting the to-be-processed pop-up information into a pop-up management model, wherein the pop-up management model is a model that is constructed based on a deep neural network and configured for determining whether the input pop-up information is pop-up information that is of interest to a user, wherein the pop-up information that is of interest to the user is information whose degree of attention is greater than a threshold; and

if an output result of the pop-up management model is information indicating that the to-be-processed pop-up information is the pop-up information that is of interest to the user, sending the to-be-processed pop-up information to a target electronic device, so that the target electronic device displays the to-be-processed pop-up information through a pop-up function.

Optionally, the method further includes:

if the output result of the pop-up management model is information indicating that the to-be-processed pop-up information is not the pop-up information that is of interest to the user, refusing to send the to-be-processed pop-up information to the target electronic device.

Optionally, the pop-up management model is trained and obtained by operations of:

constructing the pop-up management model based on the deep neural network, wherein a modeling unit of the pop-up management model is information indicating whether pop-up information is of interest to a user;

obtaining a training set, converting pop-up information in the training set into feature vectors, and marking the pop-up information in the training set with labels indicating that the pop-up information is of interest to the user or the pop-up information is not of interest to the user; and

training the pop-up management model by the feature vectors and the labels.

Optionally, the pop-up management model is trained and obtained by operations of:

obtaining a training set including a plurality of pieces of pop-up information and label information corresponding to the plurality of pieces of pop-up information, wherein the label information is information indicating that the pop-up information is of interest to a user or that the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

calculating a pop-up information loss value according to the output result of each piece of pop-up information and label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the operation of inputting a feature vector of each piece of pop-up information included in the training set into the deep neural network to obtain an output result of this piece of pop-up information; and

if the deep neural network converges, taking the deep neural network using the target parameters as the pop-up management model.

Optionally, converting the pop-up information in the training set into feature vectors includes:

converting the pop-up information in the training set into the feature vectors according to display time, a display delay duration, a display location, and a specification of an electronic device used by a user.

Optionally, the deep neural network includes an input layer, an abstraction layer, and an output layer,

wherein the number of neurons included in the input layer of the deep neural network is the same as the number of dimensions of the feature vector; an activation function of the abstraction layer is a ReLu (Rectified Linear Units) function; and an activation function of the output layer is a sigmoid (S-type) function.

Optionally, after inputting the to-be-processed pop-up information into the pop-up management model, the method further includes:

adding a correspondence between the output result of the pop-up management model and the to-be-processed pop-up information to the training set.

Optionally, the pop-up information that is of interest to the user is pop-up information viewed by the user.

Optionally, the training set may be determined by operations of:

sending the obtained plurality of pieces of pop-up information to a plurality of electronic devices, so that the plurality of electronic devices respectively display the received pop-up information through the pop-up function, and record whether the user views the received pop-up information;

receiving a correspondence, returned by the plurality of electronic devices, between the pop-up information and a fact whether the user views the pop-up information; and

determining the training set according to the received correspondence.

In a second aspect, an embodiment of the present application provides a model training method including:

constructing a pop-up management model based on a deep neural network, wherein a modeling unit of the pop-up management model is information indicating whether pop-up information is of interest to a user, wherein the pop-up information that is of interest to the user is information whose degree of attention is greater than a threshold;

obtaining a training set, converting pop-up information in the training set into feature vectors, and marking the pop-up information in the training set with labels indicating that the pop-up information is of interest to the user or the pop-up information is not of interest to the user; and

training the pop-up management model by the feature vectors and the labels.

Optionally, converting pop-up information in the training set into feature vectors includes:

converting the pop-up information in the training set into the feature vectors according to display time, a display delay duration, a display location, and a specification of an electronic device used by a user.

Optionally, the deep neural network includes an input layer, an abstraction layer, and an output layer,

wherein the number of neurons included in the input layer of the deep neural network is the same as the number of dimensions of the feature vector; an activation function of the abstraction layer is a ReLu function; and an activation function of the output layer is a sigmoid function.

Optionally, the pop-up information that is of interest to the user is pop-up information viewed by the user.

Optionally, the training set may be determined by operations of:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

In a third aspect, an embodiment of the present application provides a model training method including:

obtaining a training set including a plurality of pieces of pop-up information and label information corresponding to the plurality of pieces of pop-up information, wherein the label information is information indicating that the pop-up information is of interest to a user or that the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

calculating a pop-up information loss value according to the output result of each piece of pop-up information and label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the step of inputting a feature vector of each piece of pop-up information included in the training set into the deep neural network to obtain an output result of this piece of pop-up information; and

if the deep neural network converges, taking the deep neural network using the target parameters as the pop-up management model.

Optionally, converting the pop-up information in the training set into feature vectors includes:

converting the pop-up information in the training set into the feature vectors according to display time, a display delay duration, a display location, and a specification of an electronic device used by the user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; an activation function of the output layer is a sigmoid function.

Optionally, the pop-up information that is of interest to the user is pop-up information viewed by the user.

Optionally, the training set may be determined by:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

In a fourth aspect, an embodiment of the present application provides an information processing apparatus, including:

an obtaining module, configured for obtaining to-be-processed pop-up information;

an inputting module, configured for inputting the to-be-processed pop-up information into a pop-up management model, wherein the pop-up management model is a model that is constructed based on a deep neural network and configured for determining whether the input pop-up information is pop-up information that is of interest to a user, wherein the pop-up information that is of interest to a user is information whose degree of attention is greater than a threshold; and

a sending module, configured for, if an output result of the pop-up management model is information indicating that the to-be-processed pop-up information is the pop-up information that is of interest to the user, sending the to-be-processed pop-up information to a target electronic device, so that the target electronic device displays the to-be-processed pop-up information through a pop-up function.

Optionally, the apparatus further includes:

a refusing module, configured for refusing to send the to-be-processed pop-up information to the target electronic device, if the output result of the pop-up management model is information indicating that the to-be-processed pop-up information is not the pop-up information that is of interest to the user.

Optionally, the apparatus further includes a training module configured for training and obtaining the pop-up management model, wherein the training module includes:

a constructing sub-module, configured for constructing the pop-up management model based on the deep neural network, wherein a modeling unit of the pop-up management model is information indicating whether pop-up information is of interest to a user;

a converting sub-module, configured for obtaining a training set, converting pop-up information in the training set into feature vectors, and marking the pop-up information in the training set with labels indicating that the pop-up information is of interest to the user or the pop-up information is not of interest to the user; and

a training sub-module, configured for training the pop-up management model by the feature vectors and the labels.

Optionally, the apparatus further includes a training module configured for training and obtaining the pop-up management model, wherein the training module includes:

a first obtaining sub-module, configured for obtaining a training set including a plurality of pieces of pop-up information and label information corresponding to the plurality of pieces of pop-up information, wherein the label information is information indicating that the pop-up information is of interest to a user or that the pop-up information is not of interest to a user;

a converting sub-module, configured for converting the pop-up information in the training set into feature vectors, and marking the pop-up information in the training set with labels having label information corresponding to the pop-up information;

a second obtaining sub-module, configured for obtaining a preset deep neural network, and initializing parameters of the deep neural network as target parameters;

an inputting sub-module, configured for inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

a calculating sub-module, configured for calculating a pop-up information loss value according to the output result of each piece of pop-up information and label information corresponding to this pop-up information included in the training set;

a judging sub-module, configured for determining, according to the pop-up information loss value, whether the deep neural network using the target parameters converges; and

a processing sub-module, configured for, if the judging sub-module determines that the deep neural network using the target parameters does not converge, adjusting the parameters of the deep neural network and taking the adjusted parameters as the target parameters; and if the judging sub-module determines that the deep neural network using the target parameters converges, taking the deep neural network using the target parameters as the pop-up management model.

Optionally, the converting sub-module is specifically configured for:

converting the pop-up information in the training set into the feature vectors according to display time, a display delay duration, a display location, and a specification of an electronic device used by a user.

Optionally, the deep neural network includes an input layer, an abstraction layer, and an output layer,

wherein the number of neurons included in the input layer of the deep neural network is the same as the number of dimensions of the feature vector; an activation function of the abstraction layer is a ReLu function; and an activation function of the output layer is a sigmoid function.

Optionally, the apparatus further includes:

an adding module, configured for adding a correspondence between the output result of the pop-up management model and the to-be-processed pop-up information to the training set after the to-be-processed pop-up information is input into the pop-up management model.

Optionally, the pop-up information that is of interest to the user is pop-up information viewed by the user.

Optionally, the apparatus further includes: a determining module configured for determining the training set, wherein the determining module includes:

a sending sub-module, configured for sending the obtained plurality of pieces of pop-up information to a plurality of electronic devices, so that the plurality of electronic devices display the received pop-up information through the pop-up function, and record whether the user views the received pop-up information;

a receiving sub-module, configured for receiving a correspondence, returned by the plurality of electronic devices, between the pop-up information and a fact whether the user views the pop-up information; and

an adding sub-module, configured for determining the training set according to the received correspondence.

In a fifth aspect, an embodiment of the present application provides a model training apparatus, including:

a constructing module, configured for constructing a pop-up management model based on a deep neural network, wherein a modeling unit of the pop-up management model is information indicating whether pop-up information is of interest to a user, wherein the pop-up information that is of interest to the user is information whose degree of attention is greater than a threshold;

a converting module, configured for obtaining a training set, converting pop-up information in the training set into feature vectors, and marking the pop-up information in the training set with labels indicating that the pop-up information is of interest to the user or the pop-up information is not of interest to the user; and

a training module, configured for training the pop-up management model by the feature vectors and the labels.

Optionally, the converting module is specifically configured for:

converting the pop-up information in the training set into the feature vectors according to display time, a display delay duration, a display location, and a specification of an electronic device used by a user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; and an activation function of the output layer is a sigmoid function.

Optionally, the pop-up information that is of interest to the user is pop-up information viewed by the user.

Optionally, the apparatus further includes a determining module configured for determining the training set, wherein the determining module includes:

a sending sub-module, configured for sending the obtained plurality of pieces of pop-up information to a plurality of electronic devices, so that the plurality of electronic devices display the received pop-up information through a pop-up function, and record whether the user views the received pop-up information;

a receiving sub-module, configured for receiving a correspondence, returned by the plurality of electronic devices, between the pop-up information and a fact whether the user views the pop-up information; and

an adding sub-module, configured for determining the training set according to the received correspondence.

In a sixth aspect, an embodiment of the present application provides a model training apparatus, including:

a first obtaining module, configured for obtaining a training set including a plurality of pieces of pop-up information and label information corresponding to the plurality of pieces of pop-up information, wherein the label information is information indicating that the pop-up information is of interest to a user or that the pop-up information is not of interest to a user;

a converting module, configured for converting the pop-up information in the training set into feature vectors, and marking the pop-up information in the training set with labels having label information corresponding to the pop-up information;

a second obtaining module, configured for obtaining a preset deep neural network, and initializing parameters of the deep neural network as target parameters;

an inputting module, configured for inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

a calculating module, configured for calculating a pop-up information loss value according to the output result of each piece of pop-up information and label information corresponding to this pop-up information included in the training set;

a judging module, configured for determining, according to the pop-up information loss value, whether the deep neural network using the target parameters converges; and

a processing module, configured for, if the judging module determines that the deep neural network using the target parameters does not converge, adjusting the parameters of the deep neural network and taking the adjusted parameters as the target parameters; and if the judging module determines that the deep neural network using the target parameters converges, taking the deep neural network using the target parameters as the pop-up management model.

Optionally, the converting module is specifically configured for:

converting the pop-up information in the training set into the feature vectors according to display time, a display delay duration, a display location, and a specification of an electronic device used by a user.

Optionally, the deep neural network includes an input layer, an abstraction layer, and an output layer,

wherein the number of neurons included in the input layer of the deep neural network is the same as the number of dimensions of the feature vector; an activation function of the abstraction layer is a ReLu function; an activation function of the output layer is a sigmoid function.

Optionally, the pop-up information that is of interest to the user is pop-up information viewed by the user.

Optionally, the apparatus further includes a determining module configured for determining the training set; wherein the determining module includes:

a sending sub-module, configured for sending the obtained plurality of pieces of pop-up information to a plurality of electronic devices, so that the plurality of electronic devices display the received pop-up information through a pop-up function, and record whether the user views the received pop-up information;

a receiving sub-module, configured for receiving a correspondence, returned by the plurality of electronic devices, between the pop-up information and a fact whether the user views the pop-up information; and

an adding sub-module, configured for determining the training set according to the received correspondence.

In a seventh aspect, an embodiment of the present application provides an electronic device including a processor, a communication interface, a memory and a communication bus; wherein the processor, the memory and the communication interface communicate with each other via the communication bus;

the memory stores a computer program; and

the processor executes the computer program stored in the memory to implement any step of the information processing method according to the first aspect.

In an eighth aspect, an embodiment of the present application provides an electronic device including a processor, a communication interface, a memory and a communication bus; wherein the processor, the memory and the communication interface communicate with each other via the communication bus;

the memory stores a computer program; and

the processor executes the computer program stored in the memory to implement any step of the model training method according to the second aspect.

In a ninth aspect, an embodiment of the present application provides an electronic device including a processor, a communication interface, a memory and a communication bus; wherein the processor, the memory and the communication interface communicate with each other via the communication bus;

the memory stores a computer program; and

the processor executes the computer program stored in the memory to implement any step of the model training method according to the third aspect.

In a tenth aspect, an embodiment of the present application provides a storage medium for storing a computer program which, when executed by a processor, implements any step of the information processing method according to the first aspect.

In an eleventh aspect, an embodiment of the present application provides a storage medium for storing a computer program which, when executed by a processor, implements any step of the model training method according to the second aspect.

In a twelfth aspect, an embodiment of the present application provides a storage medium for storing a computer program which, when executed by a processor, implements any step of the model training method according to the third aspect.

In a thirteenth aspect, an embodiment of the present application provides a computer program, wherein the computer program, when executed by a processor, implements any step of the information processing method according to the first aspect.

In a fourteenth aspect, an embodiment of the present application provides a computer program, wherein the computer program, when executed by a processor, implements any step of the model training method according to the second aspect.

In a fifteenth aspect, an embodiment of the present application provides a computer program, wherein the computer program, when executed by a processor, implements any step of the model training method according to the third aspect.

In the embodiments of the present application, a pop-up management model is constructed based on a deep neural network, and the pop-up management model is used to determine whether the input pop-up information is pop-up information that is of interest to a user. In this case, the obtained to-be-processed pop-up information is input into the pop-up management model. If an output result of the pop-up management model is that the to-be-processed pop-up information is the pop-up information of interest to the user, then the to-be-processed pop-up information is sent to an electronic device and the electronic device displays the pop-up information through a pop-up function. In this way, the number of pieces of pop-up information that is not of interest to the user received by the electronic device is effectively reduced, the problem that the electronic device displays a large amount of pop-up information that is not of interest to the user is solved and the user experience is improved. Of course, it is not necessary to achieve all of the above advantages at the same time in implementing any of the products or methods of the present application.

### BRIEF DESCRIPTION OF THE DRAWINGS

In order to more clearly describe the technical solutions of the embodiments of the present application or of the prior art, drawings that need to be used in embodiments and the prior art will be briefly described below. Obviously, the drawings provided below are for only some embodiments of the present application; those skilled in the art can also obtain other drawings based on these drawings without any creative efforts.

FIG. 1 is a flowchart of a model training method according to an embodiment of the present application;

FIG. 2 is a diagram of a pop-up management model used in the embodiment of the present application;

FIG. 3 is a flowchart of a method for determining a training set according to an embodiment of the present disclosure;

FIG. 4 is a first flowchart of an information processing method according to an embodiment of the present application;

FIG. 5 is a second flowchart of an information processing method according to an embodiment of the present disclosure;

FIG. 6 is a structural diagram of a model training apparatus according to an embodiment of the present application;

FIG. 7 is a first structural diagram of an information processing apparatus according to an embodiment of the present disclosure;

FIG. 8 is a second structural diagram of an information processing apparatus according to an embodiment of the present disclosure;

FIG. 9 is a third structural diagram of an information processing apparatus according to an embodiment of the present disclosure;

FIG. 10 is a first structural diagram of an electronic device according to an embodiment of the present disclosure;

FIG. 11 is a second structural diagram of an electronic device according to an embodiment of the present application.

### DETAILED DESCRIPTION OF THE INVENTION

The embodiments of the present application will be described below in details with reference to the appended drawings. It should be noted that the described embodiments are only some, and not all, of the embodiments of the present application. All other embodiments obtained based on the embodiments of the present application by those skilled in the art without any creative efforts fall into the scope of protection defined by the present application.

To facilitate understanding, the terms appearing in the embodiments of the present application are explained below.

“Pop-up information” refers to information displayed by the electronic device through the pop-up function, for example, push information sent by a server running an application, an incoming call to one electronic device from another electronic device, a short message to one electronic device from another electronic device, or the like.

“Pop-up information that is of interest to a user” refers to pop-up information related to the user's behavioral habit, that is, information whose degree of attention is greater than a threshold. In the embodiments of the present application, the degree of attention may be determined by a click frequency. For example, if the user frequently clicks through the shopping webpage and the click frequency is greater than a threshold, the pop-up information related to the shopping may be determined as the pop-up information that is of interest to the user. For example, the frequency at which the user clicks to view push information of an application is greater than a threshold, the push information of the application may be determined as the pop-up information that is of interest to the user. For example, if the frequency at which the user answers an unknown incoming call is greater than a threshold, then the incoming call may be determined as the pop-up information that is of interest to the user.

At present, in the network, there is a lot of pop-up information that is of interest or is not of interest to the user. If the pop-up information is all sent to the electronic device, the direct result is that the electronic device displays a large amount of pop-up information that is not of interest to the user through the pop-up function, which affects the normal use of the electronic device by the user, and brings the poor user experience.

In order to solve the problem that the electronic device displays a large amount of pop-up information that is not of interest to the user, and to improve the user experience, the embodiments of the present application provide information processing and model training methods and apparatuses, electronic devices, and storage mediums. The information processing and model training methods and apparatuses can be applied to a cloud server.

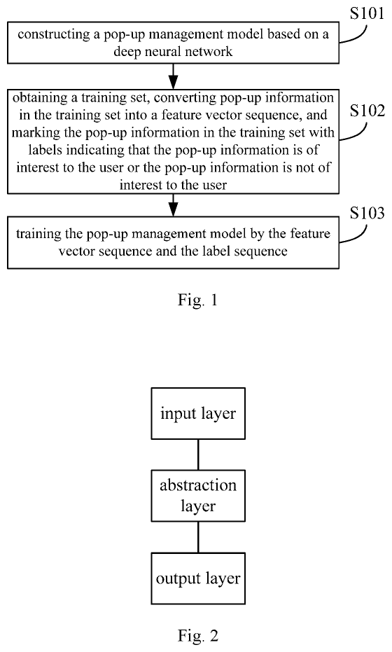

Referring to FIG. 1, FIG. 1 is a flowchart of a model training method according to an embodiment of the present application. The method includes S101-S103.

S101: Constructing a pop-up management model based on a deep neural network.

A modeling unit of the pop-up management model is information indicating whether pop-up information is of interest to a user, that is, information indicating that the pop-up information is of interest to a user or that the pop-up information is not of interest to a user. Here, the pop-up information that is of interest to the user is information whose degree of attention is greater than a threshold. For example, the threshold is 0.8. If a degree of attention for a piece of pop-up information is 0.9 (0.9>0.8), it is determined that the pop-up information is of interest to the user.

The modeling unit is type information of an output result obtained after the pop-up management model processes input pop-up information. The initial pop-up management model is constructed based on the deep neural network.

In an embodiment of the present application, the pop-up information that is of interest to the user is information whose degree of attention is 1. After the electronic device displays the pop-up information that is of interest to the user through the pop-up function, the user will view the pop-up information. That is, the pop-up information that is of interest to the user is pop-up information viewed by the user. The pop-up information that is not of interest to the user is information whose degree of attention is 0. After the electronic device displays the pop-up information that is not of interest to the user through the pop-up function, the user will not view the pop-up information. That is, the pop-up information that is not of interest to the user is pop-up information that is not viewed by the user.

In an embodiment of the present application, after the electronic device displays the pop-up information through the pop-up function, the user can view the pop-up information by clicking the pop-up information, that is, the pop-up information that is of interest to the user is the pop-up information on which the user clicks. In addition, the user may view the pop-up information in other manners, which is not limited by the embodiment of the present application.

The deep neural network is composed of multiple neurons and is a type of forward neural network.

The deep neural network that constructs the pop-up management model consists of an input layer, an abstraction layer, and an output layer. As shown in FIG. 2, each of the layers has inputs and outputs of neurons, and the inputs of the neurons in this layer are outputs of neurons in a previous layer. The abstraction layer is used to parse a feature vector of the input information.

In an embodiment of the present application, the neurons may be deployed in the input layer, the abstraction layer, and the output layer of the deep neural network constructing the pop-up management model in such a way that the input layer includes 90 neurons, and the abstract layer includes 5 layers, wherein the first layer includes 45 neurons, the second layer includes 30 neurons, the third layer includes 20 neurons, the fourth layer includes 10 neurons, and the fifth layer includes 5 neurons.

In an embodiment of the present application, an activation function of the abstraction layer is a ReLu function; an activation function of the output layer is a sigmoid function. That is, the output layer employs a sigmoid binary classifier, and an output result thereof is information indicating that pop-up information is of interest to the user or that pop-up information is not of interest to the user.

In an embodiment of the present application, in order to ensure the accuracy of the output result of the pop-up management model, the deep neural network is constructed by different types of neural networks. For example, the deep neural network may be constructed by one or more of CNN (Convolutional Neural Network), LSTM (Long Short-Term Memory), RNN (Simple Recurrent Neural Network), and the like.

S102: Obtaining a training set, converting pop-up information in the training set into feature vectors, marking the pop-up information in the training set with labels indicating that the pop-up information is of interest to the user or the pop-up information is not of interest to the user.

The training set includes a correspondence between a large amount of pop-up information and information indicating whether the pop-up information is of interest to the user. The information in the training set indicating whether the pop-up information is of interest to the user is taken as label information corresponding to the pop-up information.

In the embodiment of the present application, the number of neurons included in the input layer of the pop-up management model is the same as the number of dimensions of a feature vector. For example, if the input layer includes 90 neurons, then the feature vector is in 90 dimensions.

The number of neurons included in the input layer of the pop-up management model is the same as the number of dimensions of the feature vector. Similarly, the number of neurons included in the input layer of the deep neural network constructing the pop-up management model is the same as the number of dimensions of the feature vector.

In an embodiment of the present application, the pop-up information included in the training set may be preconfigured by a user, or may be obtained from an electronic device having a pop-up function.

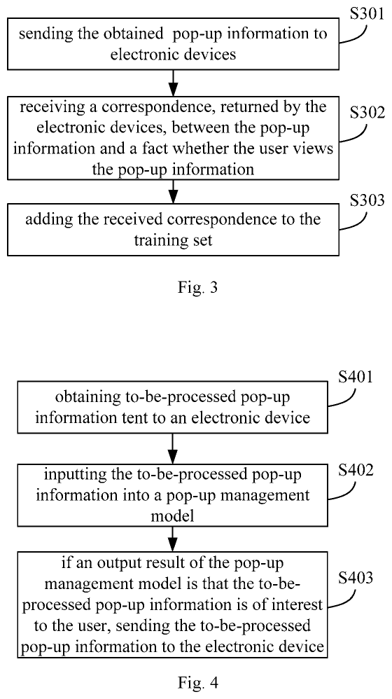

Referring to FIG. 3, FIG. 3 is a flowchart of a method for determining a training set according to an embodiment of the present disclosure. The method includes S301-S303.

S301: Sending the obtained pop-up information to electronic devices.

In S301, the obtained plurality of pieces of pop-up information are sent to a plurality of electronic devices, so as to ensure that sufficient pop-up information and label information corresponding to the pop-up information are obtained.

One electronic device may receive one piece of pop-up information, or may also receive a plurality of pieces of pop-up information. This is not limited by the embodiment of the present application.

Each electronic device displays the received pop-up information through the pop-up function. In addition, if the user views the pop-up information, the electronic device records that the user views the pop-up information; if the user does not view the pop-up information, the electronic device records that the user does not view the pop-up information. Here, the pop-up information viewed by the user can be considered as the pop-up information that is of interest to the user.

S302: Receiving a correspondence, returned by the electronic devices, between the pop-up information and a fact whether the user views the pop-up information.

In S302, the correspondence, returned by the plurality of electronic devices, between the pop-up information and a fact whether the user views the pop-up information is received.

After recording whether the user views the pop-up information, the electronic device sends the pop-up information and the record of whether the user views the pop-up information to a device that constructs the training set.

S303: Adding the received correspondence in the training set.

That is, in S303, the training set is determined according to the received correspondence.

There is a large amount of pop-up information in the network. Based on the pop-up information, a correspondence between a large amount of the pop-up information and a fact whether the user views the pop-up information can be quickly obtained. Based on the correspondence between the large amount of pop-up information and the fact whether the user views the pop-up information, the training set is constructed for training the pop-up management model subsequently.

In an embodiment of the present application, in determining the training set, training sets for different countries may be determined. For example, a training set for China is determined according to the obtained pop-up information for China, and a training set for United Kingdom is determined according to the obtained pop-up information for United Kingdom. Based on the training sets for different countries, the pop-up management models for different countries are trained and obtained, respectively. In this way, whether the received pop-up information is the pop-up information that is of interest to the user can be identified more accurately.

Here, the pop-up information for a certain country may be determined by the location of the electronic device displaying the pop-up information. For example, if the electronic device displaying the pop-up information is located in China, then the pop-up information is determined to be pop-up information for China. The pop-up information for a certain country may also be determined by a language in which the pop-up information is displayed. For example, if the pop-up information is displayed in Chinese, then the pop-up information is determined to be pop-up information for China. The pop-up information for a certain country may be determined by other methods according to actual needs, which is not limited in the embodiment of the present application.

In the model training, after the training set is obtained, data mining is performed on the pop-up information in the training set in terms of time and electronic device specifications, to obtain multi-dimensional feature vectors.

In an embodiment of the present application, the pop-up information in the training set may be converted into multi-dimensional feature vectors according to display time, a display delay duration, a display location, and a specification of an electronic device used by a user. The display time is time at which the pop-up information is displayed, which may be divided into working time or rest time, or divided into morning time or afternoon time or evening time. The display delay duration is between viewing the pop-up information and displaying the pop-up information, and the display delay duration may be an average display delay duration for all the pop-up information displayed by an electronic device.

In one embodiment of the present application, the pop-up information is pop-up information for an application. In this case, an one-dimensional feature vector of the pop-up information may be obtained based on a frequency at which the user uses the application, and is combined with the feature vectors obtained according to the display time, the display delay duration, the display location, and the specification of the electronic device used by the user, to construct multi-dimensional feature vectors.

In addition, in the model training, after the training set is obtained, according to the pop-up information included in the training set and the information indicating whether the pop-up information is of interest to the user, the pop-up information in the training set may be marked with labels indicating that the pop-up information is of interest to the user or the pop-up information is not of interest to the user. For example, if the training set records a piece of pop-up information that is viewed by the user, this piece of pop-up information is marked as 1. If the training set records a piece of pop-up information that is not viewed by the user, this piece of pop-up information is marked as 0. The label 1 indicates that the pop-up information is of interest to the user, and the label 0 indicates that the pop-up information is not of interest to the user.

S103: training the pop-up management model by the feature vectors and the labels.

The pop-up management model is trained by a back propagation algorithm with the obtained multi-dimensional feature vectors and labels. The parameters of the pop-up management model are repeatedly adjusted, until an accuracy rate of the output result of the pop-up management model reaches the threshold.

In an embodiment of the present application, in order to speed up the training of the pop-up management model, the parameters of the pop-up management model may be randomly initialized or the parameters of the pop-up management module may be initialized according to experience before the pop-up management model is trained. In addition, the parameters of the pop-up management model may be initialized by other manners, which is not limited in this application.

In the foregoing embodiments, a training set including a large amount of pop-up information is obtained; the pop-up information in the training set is converted into feature vectors; the pop-up information in the training set is marked with labels indicating that the pop-up information is of interest to the user or the pop-up information is not of interest to the user; and a pop-up management model is trained according to the obtained feature vectors and the labels. Therefore, whether pop-up information is pop-up information that is of interest to the user can more accurately identified according to the trained pop-up management model.

Based on the same inventive concept, an embodiment of the present application further provides a model training method according to the foregoing model training method. The model training method may include the following steps.

Step 01: Obtaining a training set. The training set includes a plurality of pieces of pop-up information and label information corresponding to the plurality of pieces of pop-up information. The label information is information indicating that the pop-up information is of interest to the user or the pop-up information is not of interest to the user.

In order to ensure that the trained pop-up management model is accurate and reliable, the more the pop-up information and the label information corresponding to the pop-up information in the training set, the better.

Step 02: Converting the pop-up information in the training set into feature vectors, and marking the pop-up information in the training set with labels having label information corresponding to the pop-up information.

For example, the pop-up information in the training set is converted into the feature vectors according to display time, a display delay duration, a display location, and a specification of an electronic device used by a user.

Step 03: Obtaining a preset deep neural network, and initializing parameters of the deep neural network as target parameters.

The structure of the deep neural network can be referred to the description in step S101. The parameters of the deep neural network constitute a parameter set, which can be represented by θᵢ. In order to speed up the training of the deep neural network, the parameters may be initialized according to actual needs and experience.

In this step, training-related high-level parameters, such as a learning rate, a gradient descent algorithm, and a back propagation algorithm, may be appropriately set, particularly by various methods in the related art, which is not described in detail herein.

An order of step 01 and step 03 is not limited in the embodiment of the present application.

Step 04: Inputting a feature vector of each piece of pop-up information included in the training set into the deep neural network to obtain an output result of this piece of the pop-up information. The output result of each piece of pop-up information is information indicating that the piece of pop-up information is of interest to the user or the piece of pop-up information is not of interest to the user.

For example, in inputting a feature vector of a piece of pop-up information into a preset deep neural network for processing, a first probability and a second probability are obtained. The first probability is a probability of information indicating the input pop-up information is of interest to the user, and the second probability is a probability of information indicating the input pop-up information is not of interest to the user.

If the first probability is greater than the second probability, the output result corresponding to this piece of pop-up information is information indicating that the input pop-up information is of interest to the user; otherwise, the output result corresponding to this piece of pop-up information is information indicating that the input pop-up information is not of interest to the user.

When this step is performed for the first time, the current parameter set is θ₁. When this step is performed again, the current parameter set θᵢ is obtained by adjusting the previously used parameter set θᵢ₋₁. The description is provided below in details.

Step 05: Calculating a pop-up information loss value according to an output result of each piece of pop-up information and label information corresponding to this pop-up information included in the training set;

In one example, a loss value L(θᵢ) may be obtained by using the Mean Squared Error (MSE) formula as a loss function, as shown in the following formula:

$$L ( {θ}_{i} ) = \frac{1}{H} {\sum }_{j = 1}^{H} ‖ F ( {I}_{j} \vert {θ}_{i} ) - {X}_{j} ‖ ;$$

Where H represents the number of pieces of pop-up information selected from the preset training set in a single training, Iⱼ represents the feature vector of the j-th piece of pop-up information, F(Iⱼ|θᵢ) represents the output result obtained by the deep neural network in step 04 based on the parameter set θᵢ, Xj represents the label of the j-th pop-up information, and i is the number of times that the step 04 has been performed.

Step 06: Determining, according to the pop-up information loss value, whether the deep neural network using the target parameters converges; if the deep neural network converges, performing step 07; and if the deep neural network does not converge, performing step 08.

For example, when the loss value is less than a preset threshold of loss value, the deep neural network may converge. Furthermore, when a difference between the loss value and a previously calculated loss value is less than a preset change threshold, the deep neural network may converge. This is not limited by the embodiment of the present application.

Step 07: Adjusting the parameters of the deep neural network, taking the adjusted parameters as the target parameters, and returning to the Step 04.

Specifically, the parameters in the current parameter set θᵢ may be adjusted by the back propagation algorithm to obtain an adjusted parameter set.

Step 08: Taking the deep neural network using the target parameters as the pop-up management model.

Specifically, the current parameter set θᵢ is taken as the output final parameter set θ_{final}, and the deep neural network using the final parameter set θ_{final} is taken as the trained pop-up management model.

In the foregoing embodiments, a training set including a large amount of pop-up information is obtained; the pop-up information in the training set is converted into feature vectors; the pop-up information in the training set is marked with labels indicating that the pop-up information is of interest to the user or the pop-up information is not of interest to the user; a pop-up management model is trained according to the obtained feature vectors and the labels. Therefore, whether the pop-up information is of interest to the user can more accurately identified according to the trained pop-up management model.

Based on the same inventive concept, an embodiment of the present application provides an information processing method according to the trained pop-up management model.

Referring to FIG. 4, FIG. 4 is a first flowchart of an information processing method according to an embodiment of the present application. The method includes S401-S403.

S401: Obtaining to-be-processed pop-up information sent to an electronic device.

In step S401, the to-be-processed pop-up information is obtained. The to-be-processed pop-up information sent to the electronic device is to-be-processed pop-up information to be sent to a target electronic device.

In an embodiment of the present application, the to-be-processed pop-up information may be determined by intercepting pop-up information that is sent by other devices to the electronic device.

For example, when the electronic device runs an application, pop-up information for the application sent by a server of the application to the electronic device can be obtained, and the obtained pop-up information is used as the to-be-processed pop-up information.

For another example, the electronic device is a mobile phone, and the mobile phone receives a call from other mobile phones. At this time, an unknown incoming call is obtained, and the unknown incoming call is taken as the to-be-processed pop-up information.

In addition, if the electronic device is a mobile phone, and another mobile phone sends a short message to the mobile phone. At this time, the short message is obtained, and the obtained short message is taken as the to-be-processed pop-up information.

S402: Inputting the to-be-processed pop-up information into a pop-up management model.

The pop-up management model is a model that is constructed based on a deep neural network and configured for determining whether the input pop-up information is pop-up information that is of interest to a user. The pop-up information that is of interest to the user is information whose degree of attention is greater than a threshold.

In an embodiment of the present application, the pop-up management model described above may be trained and obtained by operations of:

constructing a pop-up management model based on the deep neural network; wherein a modeling unit of the pop-up management model is information indicating whether the pop-up information is of interest to a user;

obtaining a training set, converting the pop-up information in the training set into feature vectors, marking the pop-up information in the training set with labels indicating that the pop-up information is of interest to the user or the pop-up information is not of interest to the user; and

training the pop-up management model by the obtained feature vectors and labels.

In another embodiment of the present application, the pop-up management model can be trained and obtained by operations of:

obtaining a training set including a plurality of pieces of pop-up information and label information corresponding to the plurality of pieces of pop-up information, wherein the label information is information indicating that the pop-up information is of interest to a user or the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of the pop-up information, wherein the output result of this piece of pop-up information is information indicating that this pop-up information is of interest to the user or this pop-up information is not of interest to the user;

calculating a pop-up information loss value according to the output result of each piece of the pop-up information and the label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the operation of inputting each piece of the pop-up information included in the training set into the deep neural network to obtain an output result of this piece of the pop-up information; and

if the deep neural network converges, taking the deep neural network using the target parameters as the pop-up management model.

In an embodiment of the present application, converting the pop-up information in the training set into feature vectors includes:

converting the pop-up information in the training set into the feature vectors according to display time, a display delay duration, a display location, and a specification of an electronic device used by a user.

In an embodiment of the present application, the deep neural network includes an input layer, an abstraction layer, and an output layer.

The number of neurons included in the input layer of the deep neural network is the same as the number of dimensions of the feature vector. The activation function of the abstraction layer is a ReLu function. The activation function of the output layer is a sigmoid function.

In an embodiment of the present application, the pop-up information that is of interest to the user is pop-up information viewed by the user.

In an embodiment of the present application, the training set is determined by operations of:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

The training of the pop-up management model described above may be referred to the embodiment shown in FIG. 1.

S403: If the output result of the pop-up management model is that the to-be-processed pop-up information is pop-up information that is of interest to the user, sending the to-be-processed pop-up information to the electronic device.

In step S403, the to-be-processed pop-up information is sent to the target electronic device, if the output result of the pop-up management model is information indicating that the to-be-processed pop-up information is the pop-up information that is of interest to the user.

The target electronic device displays the to-be-processed pop-up information through a pop-up function. The to-be-processed pop-up information is the pop-up information that is of interest to the user. The to-be-processed pop-up information is displayed so as to be convenient for viewing by the user, thereby improving the user experience.

In an embodiment of the present application, referring to FIG. 5, FIG. 5 is a second flowchart of an information processing method according to an embodiment of the present application. Based on FIG. 4, the method may further include:

S404: If the output result of the pop-up management model is that the to-be-processed pop-up information is the pop-up information that is not of interest to the user, refusing to send the to-be-processed pop-up information to the electronic device.

In step S404, the to-be-processed pop-up information is refused to be sent to the target electronic device, if the output result of the pop-up management model is information indicating that the to-be-processed pop-up information is the pop-up information that is not of interest to the user.

In an embodiment of the present application, the step of refusing to send the to-be-processed pop-up information to the target electronic device may include: discarding the to-be-processed pop-up information to avoid the occupation of excessive storage space.

In an embodiment of the present application, the step of refusing to send the to-be-processed pop-up information to the target electronic device may include: intercepting the to-be-processed pop-up information, sending no to-be-processed information to the target electronic device, and recording the to-be-processed pop-up information. Then, prompt information can be periodically sent to the target electronic device to inform the user of how much pop-up information was intercepted, so that the user can timely process the recorded pop-up information.

In an embodiment of the present application, when the to-be-processed pop-up information is recorded, the feature information of the to-be-processed pop-up information may also be recorded, such as an incoming call from a certain number, pop-up information for an application, weather SMS message, and the like. In this case, prompt information may be periodically sent to the electronic device. The prompt information carries the recorded feature information of the pop-up information. Based on the feature information, the user can determine timely whether the to-be-processed pop-up information intercepted is the pop-up information that is of interest to the user. If the to-be-processed pop-up information is the pop-up information that is of interest to the user, the to-be-processed pop-up information is obtained timely.

In an embodiment of the present application, after the to-be-processed pop-up information is input into the pop-up management model, an output result of the pop-up management model is obtained. At this time, a correspondence between the output result and the to-be-processed pop-up information may be added in the training set to enrich the pop-up information included in the training set, so as to train the pop-up management model again.

In the above embodiments, a pop-up management model is constructed based on a deep neural network, and the pop-up management model is used to determine whether the input pop-up information is pop-up information that is of interest to the user. In this case, the obtained to-be-processed pop-up information is input into the pop-up management model. If the output result of the pop-up management model is that: the to-be-processed pop-up information is the pop-up information that is of interest to the user, then the to-be-processed pop-up information is sent to the electronic device, and the electronic device displays the to-be-processed pop-up information through the pop-up function. In this way, the number of pop-up information, which is not of interest to a user, received by the electronic device is effectively reduced, the problem that the electronic device displays a large amount of pop-up information that is not of interest to the user is solved, and the user experience is improved.

Corresponding to the embodiment of the method, an embodiment of the present application further provides an information processing apparatus and a model training apparatus.

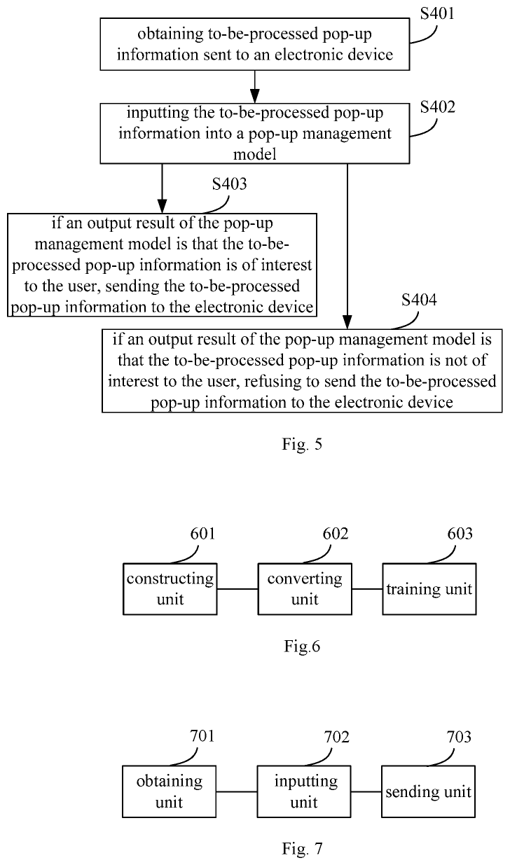

Referring to FIG. 6, FIG. 6 is a schematic structural diagram of a model training apparatus according to an embodiment of the present application. The apparatus includes:

a constructing unit 601, configured for constructing a pop-up management model based on a deep neural network, wherein a modeling unit of the pop-up management model is information indicating whether pop-up information is of interest to a user, wherein the pop-up information that is of interest to the user is information whose degree of attention is greater than a threshold;

a converting unit 602, configured for obtaining a training set, converting pop-up information in the training set into feature vectors, and marking the pop-up information in the training set with labels indicating that the pop-up information is of interest to the user or the pop-up information is not of interest to the user;

a training unit 603, configured for training the pop-up management model by the feature vectors and the labels.

The constructing unit 601 is a constructing module, the converting unit is a converting module, and the training unit is a training module.

Optionally, the converting unit 602 may be specifically configured for:

converting the pop-up information in the training set into the feature vectors according to display time, a display delay duration, a display location, and a specification of an electronic device used by a user.

Optionally, the deep neural network includes an input layer, an abstraction layer, and an output layer,

wherein the number of neurons included in the input layer of the deep neural network is the same as the number of dimensions of the feature vector; an activation function of the abstraction layer is a ReLu function; and an activation function of the output layer is a sigmoid function.

Optionally, the pop-up information that is of interest to the user is pop-up information viewed by the user.

Optionally, the model training apparatus may further include a determining unit configured for determining the training set.

In this case, the determining unit may include:

a sending sub-unit, configured for sending the obtained plurality of pieces of pop-up information to a plurality of electronic devices, so that the plurality of electronic devices display the received pop-up information through a pop-up function, and record whether the user views the received pop-up information;

a receiving sub-unit, configured for receiving a correspondence, returned by the plurality of electronic devices, between the pop-up information and a fact whether the user views the pop-up information; and

an adding sub-unit, configured for determining the training set according to the received correspondence.

The determining unit is a determining module, the sending sub-unit is a sending sub-module, the receiving sub-unit is a receiving sub-module, and the adding sub-unit is a adding sub-module.

In the foregoing embodiments, a training set including a large amount of pop-up information is obtained; the pop-up information in the training set is converted into feature vectors, the pop-up information in the training set is marked with labels indicating that the pop-up information is of interest to the user or the pop-up information is not of interest to the user; and a pop-up management model is trained according to the obtained feature vectors and the labels. In this way, whether the pop-up information is of interest to the user can more accurately identified according to the trained pop-up management model.

Based on the same inventive concept, according to the embodiment of the model training method, an embodiment of the present application further provides a model training apparatus. The apparatus includes:

a first obtaining module, configured for obtaining a training set including a plurality of pieces of pop-up information and label information corresponding to the plurality of pieces of pop-up information, wherein the label information is information indicating that the pop-up information is of interest to a user or that the pop-up information is not of interest to a user;

a converting module, configured for converting the pop-up information in the training set into feature vectors, and marking the pop-up information in the training set with labels having label information corresponding to the pop-up information;

a second obtaining module, configured for obtaining a preset deep neural network, and initializing parameters of the deep neural network as target parameters;

an inputting module, configured for inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

a calculating module, configured for calculating a pop-up information loss value according to the output result of each piece of pop-up information and label information corresponding to this pop-up information included in the training set;

a judging module, configured for determining, according to the pop-up information loss value, whether the deep neural network using the target parameters converges; and

a processing module, configured for, if the judging module determines that the deep neural network using the target parameters does not converge, adjusting the parameters of the deep neural network and taking the adjusted parameters as the target parameters; and if the judging module determines that the deep neural network using the target parameters converges, taking the deep neural network using the target parameters as the pop-up management model.

Optionally, the converting module may be specifically configured for:

converting the pop-up information in the training set into the feature vectors according to display time, a display delay duration, a display location, and a specification of an electronic device used by a user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; an activation function of the output layer is a sigmoid function.

Optionally, the pop-up information that is of interest to the user is pop-up information viewed by the user.

Optionally, the model training apparatus may further include a determining module configured for determining the training set. The determining module may include:

a sending sub-module, configured for sending the obtained plurality of pieces of pop-up information to a plurality of electronic devices, so that the plurality of electronic devices display the received pop-up information through a pop-up function, and record whether the user views the received pop-up information;

a receiving sub-module, configured for receiving a correspondence, returned by the plurality of electronic devices, between the pop-up information and a fact whether the user views the pop-up information; and

an adding sub-module, configured for determining the training set according to the received correspondence.

In the foregoing embodiments, a training set including a large amount of pop-up information is obtained; the pop-up information in the training set is converted into feature vectors, and the pop-up information in the training set is marked with labels indicating that the pop-up information is of interest to the user or the pop-up information is not of interest to the user; and a pop-up management model is trained according to the obtained feature vectors and the labels. In this way, whether the pop-up information is of interest to the user can more accurately identified according to the trained pop-up management model.

Based on the same inventive concept, according to the embodiment of the foregoing information processing method, an embodiment of the present application further provides an information processing apparatus. Referring to FIG. 7, FIG. 7 is a first schematic structural diagram of an information processing apparatus according to an embodiment of the present disclosure. The apparatus includes:

an obtaining unit 701, configured for obtaining to-be-processed pop-up information;

an inputting unit 702, configured for inputting the to-be-processed pop-up information into a pop-up management model, wherein the pop-up management model is a model that is constructed based on a deep neural network and configured for determining whether the input pop-up information is pop-up information that is of interest to a user, wherein the pop-up information that is of interest to a user is information whose degree of attention is greater than a threshold; and

a sending unit 703, configured for, if an output result of the pop-up management model is information indicating that the to-be-processed pop-up information is the pop-up information that is of interest to the user, sending the to-be-processed pop-up information to a target electronic device, so that the target electronic device displays the to-be-processed pop-up information through a pop-up function.

The obtaining unit 701 is an obtaining module, the inputting unit 702 is an inputting module, and the sending unit 703 is a sending module.

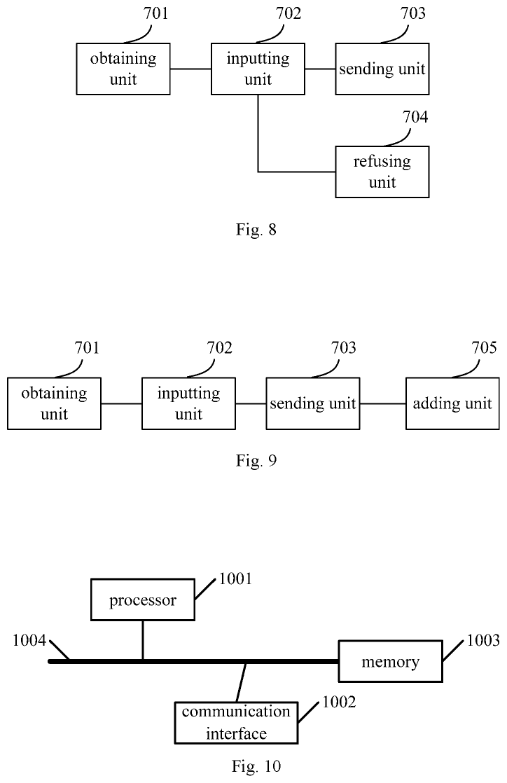

Optionally, referring to a second structural diagram of an information processing apparatus shown in FIG. 8, based on FIG. 7, the apparatus may further include:

a refusing unit 704, configured for refusing to send the to-be-processed pop-up information to the target electronic device, if the output result of the pop-up management model is information indicating that the to-be-processed pop-up information is not the pop-up information that is of interest to the user.

The refusing unit 704 is a refusing module.

Optionally, the information processing apparatus may further include a training unit, configured for training and obtaining the pop-up management model. In this case, the training unit may include:

a constructing sub-unit, configured for constructing the pop-up management model based on the deep neural network, wherein a modeling unit of the pop-up management model is information indicating whether pop-up information is of interest to a user;

a converting sub-unit, configured for obtaining a training set, converting pop-up information in the training set into feature vectors, and marking the pop-up information in the training set with labels indicating that the pop-up information is of interest to the user or the pop-up information is not of interest to the user; and

a training sub-unit, configured for training the pop-up management model by the feature vectors and the labels.

The training unit is a training module, the constructing sub-unit is a constructing sub-module, the converting sub-unit is a converting sub-module, and the training sub-unit is a training sub-module.

Optionally, the information processing apparatus may further include a training module, configured for training and obtaining the pop-up management model. In this case, the training module may include:

a first obtaining sub-module, configured for obtaining a training set including a plurality of pieces of pop-up information and label information corresponding to the plurality of pieces of pop-up information, wherein the label information is information indicating that the pop-up information is of interest to a user or that the pop-up information is not of interest to a user;

a converting sub-module, configured for converting the pop-up information in the training set into feature vectors, and marking the pop-up information in the training set with labels having label information corresponding to the pop-up information;

a second obtaining sub-module, configured for obtaining a preset deep neural network, and initializing parameters of the deep neural network as target parameters;

an inputting sub-module, configured for inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

a calculating sub-module, configured for calculating a pop-up information loss value according to the output result of each piece of pop-up information and label information corresponding to this pop-up information included in the training set;

a judging sub-module, configured for determining, according to the pop-up information loss value, whether the deep neural network using the target parameters converges; and

a processing sub-module, configured for, if the judging sub-module determines that the deep neural network using the target parameters does not converge, adjusting the parameters of the deep neural network and taking the adjusted parameters as the target parameters; and if the judging sub-module determines that the deep neural network using the target parameters converges, taking the deep neural network using the target parameters as the pop-up management model.

Optionally, the converting sub-module may be specifically configured for:

converting the pop-up information in the training set into the feature vectors according to display time, a display delay duration, a display location, and a specification of an electronic device used by a user.

Optionally, the deep neural network includes an input layer, an abstraction layer, and an output layer,

wherein the number of neurons included in the input layer of the deep neural network is the same as the number of dimensions of the feature vector; an activation function of the abstraction layer is a ReLu function; and an activation function of the output layer is a sigmoid function.

Optionally, referring to a third structural diagram of an information processing apparatus shown in FIG. 9, based on FIG. 7, the apparatus may further include:

an adding unit 905, configured for adding a correspondence between the output result of the pop-up management model and the to-be-processed pop-up information to the training set after the to-be-processed pop-up information is input into the pop-up management model.

The adding unit is an adding module.

Optionally, the pop-up information that is of interest to the user is pop-up information viewed by the user.

Optionally, the information processing apparatus may further include: a determining unit configured for determining the training set, wherein the determining unit may include:

a sending sub-unit, configured for sending the obtained plurality of pieces of pop-up information to a plurality of electronic devices, so that the plurality of electronic devices respectively display the received pop-up information through the pop-up function, and record whether the user views the received pop-up information;

a receiving sub-unit, configured for receiving a correspondence, returned by the plurality of electronic devices, between the pop-up information and a fact whether the user views the pop-up information; and

an adding sub-unit, configured for determining the training set according to the received correspondence.

The determining unit is a determining module, the sending sub-unit is a sending sub-module, the receiving sub-unit is a receiving sub-module, and the adding sub-unit is a adding sub-module.

In the above embodiments, a pop-up management model is constructed based on a deep neural network, and the pop-up management model is used to determine whether the input pop-up information is pop-up information that is of interest to a user. In this case, the obtained to-be-processed pop-up information is input into the pop-up management model. If an output result of the pop-up management model is that the to-be-processed pop-up information is the pop-up information of interest to the user, then the to-be-processed pop-up information is sent to an electronic device and the electronic device displays the pop-up information through a pop-up function. In this way, the number of pieces of pop-up information that is not of interest to the user received by the electronic device is effectively reduced, the problem that the electronic device displays a large amount of pop-up information that is not of interest to the user is solved and the user experience is improved.

Corresponding to the embodiment of the model training method, the embodiment of the present application further provides an electronic device. As shown in FIG. 10, the electronic device includes a processor 1001, a communication interface 1002, a memory 1003, and a communication bus 1004. The processor 1001, the communication interface 1002 and the memory 1003 communicate with each other via the communication bus 1004.

The memory 1003 stores a computer program.

The processor 1001 executes the computer program stored in the memory 1003 to implement the model training method. The model training method includes:

constructing a pop-up management model based on a deep neural network, wherein a modeling unit of the pop-up management model is information indicating whether pop-up information is of interest to a user, wherein the pop-up information that is of interest to the user is information whose degree of attention is greater than a threshold;

obtaining a training set, converting pop-up information in the training set into feature vectors, and marking the pop-up information in the training set with labels indicating that the pop-up information is of interest to the user or the pop-up information is not of interest to the user; and

training the pop-up management model by the feature vectors and the labels.

Optionally, converting pop-up information in the training set into feature vectors may include:

converting the pop-up information in the training set into the feature vectors according to display time, a display delay duration, a display location, and a specification of an electronic device used by a user.

Optionally, the deep neural network includes an input layer, an abstraction layer, and an output layer,

wherein the number of neurons included in the input layer of the deep neural network is the same as the number of dimensions of the feature vector; an activation function of the abstraction layer is a ReLu function; and an activation function of the output layer is a sigmoid function.

Optionally, the pop-up information that is of interest to the user is pop-up information viewed by the user.

Optionally, the training set is determined by operations of:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

In the foregoing embodiments, a training set including a large amount of pop-up information is obtained; the pop-up information in the training set is converted into feature vectors, and the pop-up information in the training set is marked with labels indicating that the pop-up information is of interest to the user or the pop-up information is not of interest to the user; and a pop-up management model is trained according to the obtained feature vectors and the labels. In this way, whether the pop-up information is of interest to the user can more accurately identified according to the trained pop-up management model.

Corresponding to the embodiment of the model training method, an embodiment of the present application further provides an electronic device. The electronic device includes a processor, a communication interface, a memory and a communication bus. The processor, the memory and the communication interface communicate with each other via the communication bus.

The memory stores a computer program.

The processor executes the computer program stored in the memory to implement the model training method. The model training method includes:

obtaining a training set including a plurality of pieces of pop-up information and label information corresponding to the plurality of pieces of pop-up information, wherein the label information is information indicating that the pop-up information is of interest to a user or that the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

calculating a pop-up information loss value according to the output result of each piece of pop-up information and label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the step of inputting a feature vector of each piece of pop-up information included in the training set into the deep neural network to obtain an output result of this piece of pop-up information; and

if the deep neural network converges, taking the deep neural network using the target parameters as the pop-up management model.

Optionally, converting the pop-up information in the training set into feature vectors may include:

converting the pop-up information in the training set into the feature vectors according to display time, a display delay duration, a display location, and a specification of an electronic device used by the user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; an activation function of the output layer is a sigmoid function.

Optionally, the pop-up information that is of interest to the user is pop-up information viewed by the user.

Optionally, the training set is determined by:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

In the foregoing embodiments, a training set including a large amount of pop-up information is obtained; the pop-up information in the training set is converted into feature vectors, and the pop-up information in the training set is marked with labels indicating that the pop-up information is of interest to the user or the pop-up information is not of interest to the user; and a pop-up management model is trained according to the obtained feature vectors and the labels. In this way, whether the pop-up information is of interest to the user can more accurately identified according to the trained pop-up management model.

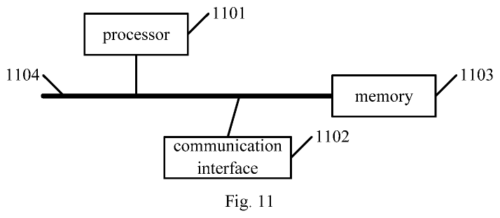

Corresponding to the embodiment of the information processing method, an embodiment of the present application further provides an electronic device. As shown in FIG. 11, the electronic device includes a processor 1101, a communication interface 1102, a memory 1103, and a communication bus 1104. The processor 1101, the communication interface 1102 and the memory 1103 communicate with each other via the communication bus 1104.

The memory 1103 stores a computer program.

The processor 1101 executes the computer program stored in the memory 1103 to implement the information processing method. The information processing method includes:

obtaining to-be-processed pop-up information;

inputting the to-be-processed pop-up information into a pop-up management model, wherein the pop-up management model is a model that is constructed based on a deep neural network and configured for determining whether the input pop-up information is pop-up information that is of interest to a user, wherein the pop-up information that is of interest to the user is information whose degree of attention is greater than a threshold; and

if an output result of the pop-up management model is information indicating that the to-be-processed pop-up information is the pop-up information that is of interest to the user, sending the to-be-processed pop-up information to a target electronic device, so that the target electronic device displays the to-be-processed pop-up information through a pop-up function.

Optionally, the information processing method may further include:

if the output result of the pop-up management model is information indicating that the to-be-processed pop-up information is not the pop-up information that is of interest to the user, refusing to send the to-be-processed pop-up information to the target electronic device.

Optionally, the pop-up management model may be trained and obtained by operations of:

constructing the pop-up management model based on the deep neural network, wherein a modeling unit of the pop-up management model is information indicating whether pop-up information is of interest to a user;

obtaining a training set, converting pop-up information in the training set into feature vectors, and marking the pop-up information in the training set with labels indicating that the pop-up information is of interest to the user or the pop-up information is not of interest to the user; and

training the pop-up management model by the feature vectors and the labels.

Optionally, the pop-up management model may be trained and obtained by operations of:

obtaining a training set including a plurality of pieces of pop-up information and label information corresponding to the plurality of pieces of pop-up information, wherein the label information is information indicating that the pop-up information is of interest to a user or that the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

calculating a pop-up information loss value according to the output result of each piece of pop-up information and label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the operation of inputting a feature vector of each piece of pop-up information included in the training set into the deep neural network to obtain an output result of this piece of pop-up information; and

if the deep neural network converges, taking the deep neural network using the target parameters as the pop-up management model.

Optionally, converting the pop-up information in the training set into feature vectors may include:

converting the pop-up information in the training set into the feature vectors according to display time, a display delay duration, a display location, and a specification of an electronic device used by a user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; and an activation function of the output layer is a sigmoid function.

Optionally, after inputting the to-be-processed pop-up information into the pop-up management model, the method may further include:

adding a correspondence between the output result of the pop-up management model and the to-be-processed pop-up information to the training set.

Optionally, the pop-up information that is of interest to the user is pop-up information viewed by the user.

Optionally, the training set is determined by operations of:

sending the obtained plurality of pieces of pop-up information to a plurality of electronic devices, so that the plurality of electronic devices respectively display the received pop-up information through the pop-up function, and record whether the user views the received pop-up information;

receiving a correspondence, returned by the plurality of electronic devices, between the pop-up information and a fact whether the user views the pop-up information; and

determining the training set according to the received correspondence.

In the above embodiments, a pop-up management model is constructed based on a deep neural network, and the pop-up management model is used to determine whether the input pop-up information is pop-up information that is of interest to a user. In this case, the obtained to-be-processed pop-up information is input into the pop-up management model. If an output result of the pop-up management model is that the to-be-processed pop-up information is the pop-up information of interest to the user, then the to-be-processed pop-up information is sent to an electronic device and the electronic device displays the pop-up information through a pop-up function. In this way, the number of pieces of pop-up information that is not of interest to the user received by the electronic device is effectively reduced, the problem that the electronic device displays a large amount of pop-up information that is not of interest to the user is solved and the user experience is improved.

The communication bus may be a PCI (Peripheral Component Interconnect) bus or an EISA (Extended Industry Standard Architecture) bus. The communication bus may be divided into an address bus, a data bus, a control bus, and the like.

The communication interface is used for communication between the above electronic device and other devices.

The memory may include a RAM (Random Access Memory), and may also include NVM (Non-Volatile Memory), such as at least one disk storage. Optionally, the memory may also be at least one storage device located away from the aforementioned processor.

The processor may be a general purpose processor, including CPU (Central Processing Unit), NP (Network Processor), or the like; or DSP (Digital Signal Processing), ASIC (Application Specific Integrated Circuit), FPGA (Field-Programmable Gate Array) or other programmable logic devices, discrete gates or transistor logic devices, discrete hardware components.

Corresponding to the embodiment of the model training method, an embodiment of the present application further provides a storage medium. A computer program is stored in the storage medium. The computer program, when executed by a processor, implements the model training method. The model training method includes:

constructing a pop-up management model based on a deep neural network, wherein a modeling unit of the pop-up management model is information indicating whether pop-up information is of interest to a user, wherein the pop-up information that is of interest to the user is information whose degree of attention is greater than a threshold;

obtaining a training set, converting pop-up information in the training set into feature vectors, and marking the pop-up information in the training set with labels indicating that the pop-up information is of interest to the user or the pop-up information is not of interest to the user; and

training the pop-up management model by the feature vectors and the labels.

Optionally, converting pop-up information in the training set into feature vectors may include:

converting the pop-up information in the training set into the feature vectors according to display time, a display delay duration, a display location, and a specification of an electronic device used by a user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; and an activation function of the output layer is a sigmoid function.

Optionally, the pop-up information that is of interest to the user is pop-up information viewed by the user.

Optionally, the training set is determined by operations of:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

In the foregoing embodiments, a training set including a large amount of pop-up information is obtained; the pop-up information in the training set is converted into feature vectors, and the pop-up information in the training set is marked with labels indicating that the pop-up information is of interest to the user or the pop-up information is not of interest to the user; and a pop-up management model is trained according to the obtained feature vectors and the labels. In this way, whether the pop-up information is of interest to the user can more accurately identified according to the trained pop-up management model.

Corresponding to the embodiment of the model training method, an embodiment of the present application further provides a storage medium. A computer program is stored in the storage medium. The computer program, when executed by a processor, implements the model training method. The model training method includes:

obtaining a training set including a plurality of pieces of pop-up information and label information corresponding to the plurality of pieces of pop-up information, wherein the label information is information indicating that the pop-up information is of interest to a user or that the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

calculating a pop-up information loss value according to the output result of each piece of pop-up information and label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the step of inputting a feature vector of each piece of pop-up information included in the training set into the deep neural network to obtain an output result of this piece of pop-up information; and

if the deep neural network converges, taking the deep neural network using the target parameters as the pop-up management model.

Optionally, converting the pop-up information in the training set into feature vectors may include:

converting the pop-up information in the training set into the feature vectors according to display time, a display delay duration, a display location, and a specification of an electronic device used by the user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; an activation function of the output layer is a sigmoid function.

Optionally, the pop-up information that is of interest to the user is pop-up information viewed by the user.

Optionally, the training set is determined by:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

In the foregoing embodiments, a training set including a large amount of pop-up information is obtained; the pop-up information in the training set is converted into feature vectors, and the pop-up information in the training set is marked with labels indicating that the pop-up information is of interest to the user or the pop-up information is not of interest to the user; and a pop-up management model is trained according to the obtained feature vectors and the labels. In this way, whether the pop-up information is of interest to the user can more accurately identified according to the trained pop-up management model.

Corresponding to the embodiment of the information processing method, an embodiment of the present application further provides a storage medium. A computer program is stored in the storage medium. The computer program, when executed by a processor, implements the information processing method. The information processing method include:

obtaining to-be-processed pop-up information;

inputting the to-be-processed pop-up information into a pop-up management model, wherein the pop-up management model is a model that is constructed based on a deep neural network and configured for determining whether the input pop-up information is pop-up information that is of interest to a user, wherein the pop-up information that is of interest to the user is information whose degree of attention is greater than a threshold; and

if an output result of the pop-up management model is information indicating that the to-be-processed pop-up information is the pop-up information that is of interest to the user, sending the to-be-processed pop-up information to a target electronic device, so that the target electronic device displays the to-be-processed pop-up information through a pop-up function.

Optionally, the information processing method may further include:

if the output result of the pop-up management model is information indicating that the to-be-processed pop-up information is not the pop-up information that is of interest to the user, refusing to send the to-be-processed pop-up information to the target electronic device.

Optionally, the pop-up management model may be trained and obtained by operations of:

constructing the pop-up management model based on the deep neural network, wherein a modeling unit of the pop-up management model is information indicating whether pop-up information is of interest to a user;

obtaining a training set, converting pop-up information in the training set into feature vectors, and marking the pop-up information in the training set with labels indicating that the pop-up information is of interest to the user or the pop-up information is not of interest to the user; and

training the pop-up management model by the feature vectors and the labels.

Optionally, the pop-up management model may be trained and obtained by operations of:

obtaining a training set including a plurality of pieces of pop-up information and label information corresponding to the plurality of pieces of pop-up information, wherein the label information is information indicating that the pop-up information is of interest to a user or that the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

calculating a pop-up information loss value according to the output result of each piece of pop-up information and label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the operation of inputting a feature vector of each piece of pop-up information included in the training set into the deep neural network to obtain an output result of this piece of pop-up information; and

if the deep neural network converges, taking the deep neural network using the target parameters as the pop-up management model.

Optionally, converting the pop-up information in the training set into feature vectors may include:

converting the pop-up information in the training set into the feature vectors according to display time, a display delay duration, a display location, and a specification of an electronic device used by a user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; and an activation function of the output layer is a sigmoid function.

Optionally, after inputting the to-be-processed pop-up information into the pop-up management model, the method may further include:

adding a correspondence between the output result of the pop-up management model and the to-be-processed pop-up information to the training set.

Optionally, the pop-up information that is of interest to the user is pop-up information viewed by the user.

Optionally, the training set may be determined by operations of:

sending the obtained plurality of pieces of pop-up information to a plurality of electronic devices, so that the plurality of electronic devices respectively display the received pop-up information through the pop-up function, and record whether the user views the received pop-up information;

receiving a correspondence, returned by the plurality of electronic devices, between the pop-up information and a fact whether the user views the pop-up information; and

determining the training set according to the received correspondence.

In the above embodiments, a pop-up management model is constructed based on a deep neural network, and the pop-up management model is used to determine whether the input pop-up information is pop-up information that is of interest to a user. In this case, the obtained to-be-processed pop-up information is input into the pop-up management model. If an output result of the pop-up management model is that the to-be-processed pop-up information is the pop-up information of interest to the user, then the to-be-processed pop-up information is sent to an electronic device and the electronic device displays the pop-up information through a pop-up function. In this way, the number of pieces of pop-up information that is not of interest to the user received by the electronic device is effectively reduced, the problem that the electronic device displays a large amount of pop-up information that is not of interest to the user is solved and the user experience is improved.

Corresponding to the embodiment of the model training method, an embodiment of the present application further provides a computer program which, when executed by a processor, implements the model training method. The model training method includes:

constructing a pop-up management model based on a deep neural network, wherein a modeling unit of the pop-up management model is information indicating whether pop-up information is of interest to a user, wherein the pop-up information that is of interest to the user is information whose degree of attention is greater than a threshold;

obtaining a training set, converting pop-up information in the training set into feature vectors, and marking the pop-up information in the training set with labels indicating that the pop-up information is of interest to the user or the pop-up information is not of interest to the user; and

training the pop-up management model by the feature vectors and the labels.

Optionally, converting pop-up information in the training set into feature vectors may include:

converting the pop-up information in the training set into the feature vectors according to display time, a display delay duration, a display location, and a specification of an electronic device used by a user.

Optionally, the deep neural network includes an input layer, an abstraction layer, and an output layer,

wherein the number of neurons included in the input layer of the deep neural network is the same as the number of dimensions of the feature vector; an activation function of the abstraction layer is a ReLu function; and an activation function of the output layer is a sigmoid function.

Optionally, the pop-up information that is of interest to the user is pop-up information viewed by the user.

Optionally, the training set is determined by operations of:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

In the foregoing embodiments, a training set including a large amount of pop-up information is obtained; the pop-up information in the training set is converted into feature vectors, and the pop-up information in the training set is marked with labels indicating that the pop-up information is of interest to the user or the pop-up information is not of interest to the user; and a pop-up management model is trained according to the obtained feature vectors and the labels. In this way, whether the pop-up information is of interest to the user can more accurately identified according to the trained pop-up management model.

Corresponding to the embodiment of the model training method, an embodiment of the present application further provides a computer program which, when executed by the processor, implements the model training method. The model training method includes:

obtaining a training set including a plurality of pieces of pop-up information and label information corresponding to the plurality of pieces of pop-up information, wherein the label information is information indicating that the pop-up information is of interest to a user or that the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

calculating a pop-up information loss value according to the output result of each piece of pop-up information and label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the step of inputting a feature vector of each piece of pop-up information included in the training set into the deep neural network to obtain an output result of this piece of pop-up information; and

if the deep neural network converges, taking the deep neural network using the target parameters as the pop-up management model.

Optionally, converting the pop-up information in the training set into feature vectors may include:

converting the pop-up information in the training set into the feature vectors according to display time, a display delay duration, a display location, and a specification of an electronic device used by the user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; an activation function of the output layer is a sigmoid function.

Optionally, the pop-up information that is of interest to the user is pop-up information viewed by the user.

Optionally, the training set may be determined by:

sending the obtained plurality of pieces of pop-up information to a plurality of electronic devices, so that the plurality of electronic devices respectively display the received pop-up information through a pop-up function, and record whether the user views the received pop-up information;

receiving a correspondence, returned by the plurality of electronic devices, between the pop-up information and a fact whether the user views the pop-up information; and

determining the training set according to the received correspondence.

In the foregoing embodiments, a training set including a large amount of pop-up information is obtained; the pop-up information in the training set is converted into feature vectors, and the pop-up information in the training set is marked with labels indicating that the pop-up information is of interest to the user or the pop-up information is not of interest to the user; and a pop-up management model is trained according to the obtained feature vectors and the labels. In this way, whether the pop-up information is of interest to the user can more accurately identified according to the trained pop-up management model.

Corresponding to the embodiment of the information processing method, an embodiment of the present application further provides a computer program which, when executed by the processor, implements the information processing method. The information processing method includes:

obtaining to-be-processed pop-up information;

inputting the to-be-processed pop-up information into a pop-up management model, wherein the pop-up management model is a model that is constructed based on a deep neural network and configured for determining whether the input pop-up information is pop-up information that is of interest to a user, wherein the pop-up information that is of interest to the user is information whose degree of attention is greater than a threshold; and

if an output result of the pop-up management model is information indicating that the to-be-processed pop-up information is the pop-up information that is of interest to the user, sending the to-be-processed pop-up information to a target electronic device, so that the target electronic device displays the to-be-processed pop-up information through a pop-up function.

Optionally, the information processing method may further include:

if the output result of the pop-up management model is information indicating that the to-be-processed pop-up information is not the pop-up information that is of interest to the user, refusing to send the to-be-processed pop-up information to the target electronic device.

Optionally, the pop-up management model may be trained and obtained by operations of:

constructing the pop-up management model based on the deep neural network, wherein a modeling unit of the pop-up management model is information indicating whether pop-up information is of interest to a user;

obtaining a training set, converting pop-up information in the training set into feature vectors, and marking the pop-up information in the training set with labels indicating that the pop-up information is of interest to the user or the pop-up information is not of interest to the user; and

training the pop-up management model by the feature vectors and the labels.

Optionally, the pop-up management model may be trained and obtained by operations of:

obtaining a training set including a plurality of pieces of pop-up information and label information corresponding to the plurality of pieces of pop-up information, wherein the label information is information indicating that the pop-up information is of interest to a user or that the pop-up information is not of interest to a user;

converting the pop-up information in the training set into feature vectors, and marking the pop-up information in the training set with labels having label information corresponding to the pop-up information;

obtaining a preset deep neural network, and initializing parameters of the deep neural network as target parameters;

inputting a feature vector of each piece of pop-up information included in the training set into the deep neural network to obtain an output result of this piece of pop-up information, wherein the output result of this piece of pop-up information is information indicating that this pop-up information is of interest to the user or that this pop-up information is not of interest to the user;

calculating a pop-up information loss value according to the output result of each piece of pop-up information and label information corresponding to this pop-up information included in the training set;

determining, according to the pop-up information loss value, whether the deep neural network using the target parameters converges;

if the deep neural network does not converge, adjusting the parameters of the deep neural network, taking the adjusted parameters as the target parameters, and returning to the operation of inputting a feature vector of each piece of pop-up information included in the training set into the deep neural network to obtain an output result of this piece of pop-up information; and

if the deep neural network converges, taking the deep neural network using the target parameters as the pop-up management model.

Optionally, converting the pop-up information in the training set into feature vectors may include:

converting the pop-up information in the training set into the feature vectors according to display time, a display delay duration, a display location, and a specification of an electronic device used by a user.

Optionally, the deep neural network includes an input layer, an abstraction layer, and an output layer;

wherein the number of neurons included in the input layer of the deep neural network is the same as the number of dimensions of the feature vector; an activation function of the abstraction layer is a ReLu function; and an activation function of the output layer is a sigmoid function.

Optionally, after inputting the to-be-processed pop-up information into the pop-up management model, the method may further include:

adding a correspondence between the output result of the pop-up management model and the to-be-processed pop-up information to the training set.

Optionally, the pop-up information that is of interest to the user is pop-up information viewed by the user.

Optionally, the training set is determined by operations of:

sending the obtained plurality of pieces of pop-up information to a plurality of electronic devices, so that the plurality of electronic devices respectively display the received pop-up information through the pop-up function, and record whether the user views the received pop-up information;

receiving a correspondence, returned by the plurality of electronic devices, between the pop-up information and a fact whether the user views the pop-up information; and

determining the training set according to the received correspondence.

In the foregoing embodiments, a pop-up management model is constructed based on a deep neural network, and the pop-up management model is used to determine whether the input pop-up information is pop-up information that is of interest to a user. In this case, the obtained to-be-processed pop-up information is input into the pop-up management model. If an output result of the pop-up management model is that the to-be-processed pop-up information is the pop-up information of interest to the user, then the to-be-processed pop-up information is sent to an electronic device and the electronic device displays the to-be-processed pop-up information through a pop-up function. In this way, the number of pieces of pop-up information that is not of interest to the user received by the electronic device is effectively reduced, the problem that the electronic device displays a large amount of pop-up information that is not of interest to the user is solved and the user experience is improved.

It should be noted that the relationship terms here, such as “first,” “second,” and the like are only used to distinguish one entity or operation from another entity or operation, but do not necessarily require or imply that there is actual relationship or order between these entities or operations. Moreover, the terms “include,” “comprise,” or any variants thereof are intended to cover a non-exclusive inclusion, such that processes, methods, articles, or devices, including a series of elements, include not only those elements that have been listed, but also other elements that have not specifically been listed or the elements intrinsic to these processes, methods, articles, or devices. Without further limitations, elements limited by the wording “comprise(s) a/an . . . ” and “include(s) a/an” do not exclude additional identical elements in the processes, methods, articles, or devices, including the listed elements.

All of the embodiments in the description are described in a correlated manner, and identical or similar parts in various embodiments can refer to one another. In addition, the description for each embodiment focuses on the differences from other embodiments. In particular, the embodiments of the model training apparatus, the information processing apparatus, the electronic device, the storage medium, and the computer program are described briefly, since they are basically similar to the embodiments of the model training method and the information processing method, and the related contents can refer to the description of the embodiments of the model training method and the information processing method.

In the several embodiments according to the present application, it should be understood that the disclosed system, apparatus, and method may be implemented in other manners. For example, the embodiments of the apparatus described above are merely illustrative. For example, the modules or units are divided only based on logic functions. In actual implementation, there may be another division manner, for example, multiple units or components may be combined or may be integrated into another system, or some features may be ignored or not executed. In addition, the mutual coupling or direct coupling or communication connection shown or discussed may be an indirect coupling or communication connection through some interfaces, devices or units, and may be in an electrical, mechanical or other form.

The units described as separate components may or may not be physically separated, and the components displayed as units may or may not be physical units, that is, may be located in one place, or may be distributed to multiple network units. Some or all of the units may be selected according to actual needs to achieve the purpose of the solution of the embodiment.

In addition, all functional units in all embodiments of the present application may be integrated into one processing unit, or all of the units may exist physically separately, or two or more units may be integrated into one unit. The above integrated unit may be implemented in the form of hardware or in the form of a software functional unit.

The integrated unit, if implemented in the form of a software functional unit and sold or used as a standalone product, may be stored in a computer readable storage medium. Based on such understanding, the technical solution of the present application or a part of the technical solution that contributes to the related art, or the whole or part of the technical solution may be embodied in the form of a software product. The computer software product is stored in a storage medium, including a number of instructions to cause a computer device (which may be a personal computer, server, or network device, etc.) or a processor to perform all or part of the steps of the methods described in various embodiments of the present application. The foregoing storage medium in which the program code may be stored, includes: a U disk, a mobile hard disk, a read only memory (ROM), a random access memory (RAM), a magnetic disk, or an optical disk.

The embodiments described above are simply preferable embodiments of the present application, and are not intended to limit the scope of protection of the present application. Any modifications or substitutions easily conceived by any person skilled in the art within the technical scope disclosed in the present application fall within the scope of protection of this application. Therefore, the scope of protection of this application shall be defined by the appended claims.

1. An information processing method, comprising:
obtaining to-be-processed pop-up information;
inputting the to-be-processed pop-up information into a pop-up management model, wherein the pop-up management model is a model that is constructed based on a deep neural network and configured for determining whether the input pop-up information is pop-up information that is of interest to a user, wherein the pop-up information that is of interest to the user is information whose degree of attention is greater than a threshold; and
if an output result of the pop-up management model is information indicating that the to-be-processed pop-up information is the pop-up information that is of interest to the user, sending the to-be-processed pop-up information to a target electronic device, so that the target electronic device displays the to-be-processed pop-up information through a pop-up function.

2. The method according to claim 1, further comprising:
if the output result of the pop-up management model is information indicating that the to-be-processed pop-up information is not the pop-up information that is of interest to the user, refusing to send the to-be-processed pop-up information to the target electronic device.

3. The method according to claim 1, wherein the pop-up management model is trained and obtained by operations of:
constructing the pop-up management model based on the deep neural network, wherein a modeling unit of the pop-up management model is information indicating whether pop-up information is of interest to a user;
obtaining a training set, converting pop-up information in the training set into feature vectors, and marking the pop-up information in the training set with labels indicating that the pop-up information is of interest to the user or the pop-up information is not of interest to the user; and
training the pop-up management model by the feature vectors and the labels.

4. The method according to claim 1, wherein, the pop-up management model is trained and obtained by operations of:
obtaining a training set comprising a plurality of pieces of pop-up information and label information corresponding to the plurality of pieces of pop-up information, wherein the label information is information indicating that the pop-up information is of interest to the user or that the pop-up information is not of interest to the user;
converting the pop-up information in the training set into feature vectors, and marking the pop-up information in the training set with labels having label information corresponding to the pop-up information;
obtaining a preset deep neural network, and initializing parameters of the deep neural network as target parameters;
inputting a feature vector of each piece of pop-up information comprised in the training set into the deep neural network to obtain an output result of this piece of pop-up information, wherein the output result of this piece of pop-up information is information indicating that this pop-up information is of interest to the user or that this pop-up information is not of interest to the user;
calculating a pop-up information loss value according to the output result of each piece of pop-up information and label information corresponding to this pop-up information comprised in the training set;
determining, according to the pop-up information loss value, whether the deep neural network using the target parameters converges;
if the deep neural network does not converge, adjusting the parameters of the deep neural network, taking the adjusted parameters as the target parameters, and returning to the operation of inputting a feature vector of each piece of pop-up information comprised in the training set into the deep neural network to obtain an output result of this piece of pop-up information; and
if the deep neural network converges, taking the deep neural network using the target parameters as the pop-up management model.

5. The method according to claim 3, wherein, converting the pop-up information in the training set into feature vectors comprises:
converting the pop-up information in the training set into the feature vectors according to display time, a display delay duration, a display location, and a specification of an electronic device used by a user.

6. The method according to claim 3, wherein, the deep neural network comprises an input layer, an abstraction layer, and an output layer,
wherein the number of neurons comprised in the input layer of the deep neural network is the same as the number of dimensions of the feature vector; an activation function of the abstraction layer is a Rectified Linear Units (ReLu) function; and an activation function of the output layer is an S-type (sigmoid) function.

7. The method according to claim 3, wherein, after inputting the to-be-processed pop-up information into the pop-up management model, the method further comprises:
adding a correspondence between the output result of the pop-up management model and the to-be-processed pop-up information to the training set.

8. The method according to claim 3, wherein, the pop-up information that is of interest to the user is pop-up information viewed by the user,
wherein, the training set is determined by operations of:
sending the obtained plurality of pieces of pop-up information to a plurality of electronic devices, so that the plurality of electronic devices respectively display the received pop-up information through the pop-up function, and record whether the user views the received pop-up information;
receiving a correspondence, returned by the plurality of electronic devices, between the pop-up information and a fact whether the user views the pop-up information; and
determining the training set according to the received correspondence.

9. (canceled)

10. A model training method, comprising:
constructing a pop-up management model based on a deep neural network, wherein a modeling unit of the pop-up management model is information indicating whether pop-up information is of interest to a user, wherein the pop-up information that is of interest to the user is information whose degree of attention is greater than a threshold;
obtaining a training set, converting pop-up information in the training set into feature vectors, and marking the pop-up information in the training set with labels indicating that the pop-up information is of interest to the user or the pop-up information is not of interest to the user; and
training the pop-up management model by the feature vectors and the labels.

11. The method according to claim 10, wherein, converting pop-up information in the training set into feature vectors comprises:
converting the pop-up information in the training set into the feature vectors according to display time, a display delay duration, a display location, and a specification of an electronic device used by a user.

12. The method according to claim 10, wherein, the deep neural network comprises an input layer, an abstraction layer, and an output layer, wherein the number of neurons comprised in the input layer of the deep neural network is the same as the number of dimensions of the feature vector; an activation function of the abstraction layer is a Rectified Linear Units (ReLu) function; and an activation function of the output layer is an S-type (sigmoid) function.

13. The method according to claim 10, wherein, the pop-up information that is of interest to the user is pop-up information viewed by the user,
wherein, the training set is determined by operations of:
sending the obtained plurality of pieces of pop-up information to a plurality of electronic devices, so that the plurality of electronic devices respectively display the received pop-up information through a pop-up function, and record whether the user views the received pop-up information;
receiving a correspondence, returned by the plurality of electronic devices, between the pop-up information and a fact whether the user views the pop-up information; and
determining the training set according to the received correspondence.

14. (canceled)

15. A model training method, comprising:
obtaining a training set comprising a plurality of pieces of pop-up information and label information corresponding to the plurality of pieces of pop-up information, wherein the label information is information indicating that the pop-up information is of interest to a user or that the pop-up information is not of interest to a user;
converting the pop-up information in the training set into feature vectors, and marking the pop-up information in the training set with labels having label information corresponding to the pop-up information;
obtaining a preset deep neural network, and initializing parameters of the deep neural network as target parameters;
inputting a feature vector of each piece of pop-up information comprised in the training set into the deep neural network to obtain an output result of this piece of pop-up information, wherein the output result of this piece of pop-up information is information indicating that this pop-up information is of interest to the user or that this pop-up information is not of interest to the user;
calculating a pop-up information loss value according to the output result of each piece of pop-up information and label information corresponding to this pop-up information comprised in the training set;
determining, according to the pop-up information loss value, whether the deep neural network using the target parameters converges;
if the deep neural network does not converge, adjusting the parameters of the deep neural network, taking the adjusted parameters as the target parameters, and returning to the step of inputting a feature vector of each piece of pop-up information comprised in the training set into the deep neural network to obtain an output result of this piece of pop-up information; and
if the deep neural network converges, taking the deep neural network using the target parameters as the pop-up management model.

16. The method according to claim 15, wherein, converting the pop-up information in the training set into feature vectors comprises:
converting the pop-up information in the training set into the feature vectors according to display time, a display delay duration, a display location, and a specification of an electronic device used by the user.

17. The method according to claim 15, wherein, the deep neural network comprises an input layer, an abstraction layer, and an output layer,
wherein the number of neurons comprised in the input layer of the deep neural network is the same as the number of dimensions of the feature vector; an activation function of the abstraction layer is a Rectified Linear Units (ReLu) function; an activation function of the output layer is an S-type (sigmoid) function.

18. The method according to claim 15, wherein, the pop-up information that is of interest to the user is pop-up information viewed by the user,
wherein, the training set is determined by:
sending the obtained plurality of pieces of pop-up information to a plurality of electronic devices, so that the plurality of electronic devices respectively display the received pop-up information through a pop-up function, and record whether the user views the received pop-up information;
receiving a correspondence, returned by the plurality of electronic devices, between the pop-up information and a fact whether the user views the pop-up information; and
determining the training set according to the received correspondence.

19. (canceled)

20-38. (canceled)

39. An electronic device comprising a processor, a communication interface, a memory and a communication bus, wherein the processor, the memory and the communication interface communicate with each other via the communication bus;
the memory stores a computer program; and
the processor executes the computer program stored in the memory to implement the method according to claim 1.

40. An electronic device comprising a processor, a communication interface, a memory and a communication bus, wherein the processor, the memory and the communication interface communicate with each other via the communication bus;
the memory stores a computer program; and
the processor executes the computer program stored in the memory to implement the method according to claim 10.

41. An electronic device comprising a processor, a communication interface, a memory and a communication bus, wherein the processor, the memory and the communication interface communicate with each other via the communication bus;
the memory stores a computer program; and
the processor executes the computer program stored in the memory to implement the method according to claim 15.

42-47. (canceled)
